(19) United States
(12) Patent Application Publication
(10) Pub. No.: US 2012/0250350 A1
(43) Pub. Date: Oct. 4, 2012

(54) DISPLAY APPARATUS

(76) Inventors: Mangeun Kim, Seoul (KR); Moongoo Choi, Seoul (KR); Seonghun Kwon, Seoul (KR); ChilKeun Park, Seoul (KR); Hyunho Lee, Seoul (KR); Taegu Kang, Seoul (KR); Sangcheon Kim, Seoul (KR); Seongman Jeon, Seoul (KR)

(21) Appl. No.: 13/433,445

(22) Filed: Mar. 29, 2012

Related U.S. Application Data
(60) Provisional application No. 61/469,108, filed on Mar. 30, 2011.

(51) Int. Cl. G09F 13/14; F21V 8/00; F21V 13/12; G09F 13/04

(52) U.S. Cl. 362/606; 362/97.1; 362/611

(57) ABSTRACT

Provided is a display apparatus. The display apparatus includes a display panel and a backlight unit including a light source disposed at a rear side of the display panel to provide light. The light source includes a sub mount substrate, a light emitting chip mounted on a top surface of the sub mount substrate, a resin layer disposed on the top surface of the sub mount substrate to surround the light emitting chip, and a transmittance adjustment layer disposed on a top surface of the resin layer to adjust a transmitting rate of light emitted from the light emitting chip.

### TECHNICAL FIELD

The present disclosure relates to a display apparatus.

### BACKGROUND ART

As our information society develops, needs for diverse forms of display apparatuses are increasing. Accordingly, research has been carried out on various display apparatuses such as liquid crystal display devices (LCDs), plasma display panels (PDPs), electro luminescent displays (ELDs), and vacuum fluorescent displays (VFDs).

Of these, such an LCD includes a liquid crystal panel. The liquid crystal panel includes a liquid crystal layer, TFT substrates with the liquid crystal layer therebetween and facing each other, and a color filter substrate. The liquid crystal panel may use light supplied from a backlight unit to display an image because it does not emit light.

A light source mounted on the backlight unit may be one of a light emitting diode (LED) chip or an LED package including at least one LED chip.

The LED package constituting the light source may be classified into a top view type and a side view type according to a direction of a light emitting surface.

Recently, a flat fluorescent lamp (FFL) or a surface light source (SLS) is being actively applied as a light source for an LCD panel. The surface light source may represent a light source which uniformly emits light through a surface thereof and does not have a thickness. Thus, since the surface light source is utilized, the backlight unit may become thinner to realize miniaturization of the display apparatus.

### DISCLOSURE

### Technical Problem

Embodiments provide a backlight unit having a surface light source structure which is capable of effectively diffusing and transmitting light onto the entire surface thereof by using an LED light source, and a display apparatus having the same.

### Technical Solution

In one embodiment, a display apparatus includes: a display panel; and a backlight unit including a light source disposed at a rear side of the display panel to provide light, wherein the light source includes: a sub mount substrate; a light emitting chip mounted on a top surface of the sub mount substrate; a resin layer disposed on the top surface of the sub mount substrate to surround the light emitting chip; and a transmittance adjustment layer disposed on a top surface of the resin layer to adjust a transmitting rate of light emitted from the light emitting chip.

The details of one or more embodiments are set forth in the accompanying drawings and the description below. Other features will be apparent from the description and drawings, and from the claims.

### Advantageous Effects

In the display apparatus according the embodiments, the light emitted from the top view type LED light source which emits light forward (or upward) may be effectively coupled in a lateral direction. That is, the top emission LED may be realized as a lateral emission LED.

Also, according to the above-described structure, a planar light source having high efficiency may be realized at a thickness less than that of an existing planar light source.

Also, a planar light source having advantages of existing edge type and direct type LEDs may be realized.

Also, the LED packages may be two-dimensionally arranged to realize local dimming.

### DESCRIPTION OF DRAWINGS

FIG. 1 is a schematically exploded perspective view of a display apparatus according to an embodiment.

FIG. 2 is an exploded perspective view illustrating a display module of a display apparatus according to an embodiment.

FIG. 3 is a sectional view of a light source according to a first embodiment.

FIG. 4 is a sectional view of a light source according to a second embodiment.

FIG. 5 is a sectional view of a light source according to a third embodiment.

FIG. 6 is a sectional view of a light source according to a fourth embodiment.

FIG. 7 is a sectional view of a light source according to a fifth embodiment.

FIG. 8 is a sectional view of a light source according to a sixth embodiment.

FIG. 9 is a view illustrating a process of manufacturing a light source according to an embodiment.

FIG. 10 is a perspective view illustrating outer appearances of an LED package substrate and an LED package which are manufactured in the process of manufacturing the light source in FIG. 9.

FIG. 11 is a sectional view of a display module on which a light source is mounted according to an embodiment.

FIG. 12 is a sectional view of a display module according to another embodiment.

FIG. 13 is a sectional view of a display module according to another embodiment.

FIG. 14 is a sectional view of a display module according to another embodiment.

FIG. 15 is a sectional view of a light source according to a seventh embodiment.

FIG. 16 is a sectional view of a light source according to an eighth embodiment.

FIG. 17 is a sectional view of a display module according to another embodiment.

FIG. 18 is a sectional view of a display module according to another embodiment.

FIG. 19 is a sectional view of a display module according to another embodiment.

FIG. 20 is a sectional view of a display module according to another embodiment.

FIG. 21 is a plan view of the display module.

FIG. 22 is a partially cut-away perspective view of a display module according to another embodiment.

FIG. 23 is a sectional view of the display module.

FIG. 24 is a partially cut-away perspective view of a display module according to another embodiment.

FIG. 25 is a sectional view of the display module.

FIG. 26 is a view illustrating a light source spectrum of a backlight unit.

FIG. 27 is a view illustrating R, G, and B color coordinates used as a light source for a backlight unit.

### MODE FOR INVENTION

Reference will now be made in detail to the embodiments of the present disclosure, examples of which are illustrated in the accompanying drawings. Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the disclosure to those skilled in the art. Thus, in the drawings, the shapes and sizes of elements are exaggerated for clarity.

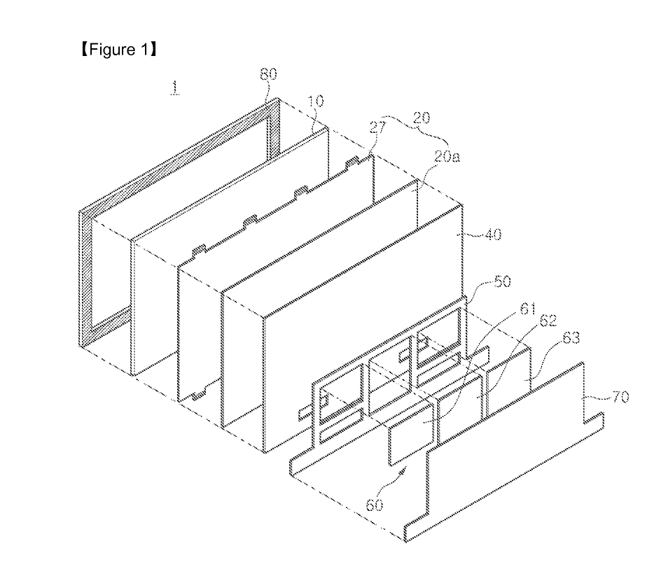

FIG. 1 is a schematically exploded perspective view of a display apparatus according to an embodiment.

Referring to FIG. 1, a display apparatus according to an embodiment includes a display panel 10, a backlight unit 20, a front cover 80, a bottom plate 40, a driving part 60, and a rear surface case 70.

In detail, the backlight unit 20 may include an optical assembly 20a and a plurality of optical sheets 27 disposed on the optical assembly 20a. The backlight unit 20 will be described below in detail.

The above-described display panel 10 and the backlight unit 20 may be modulated through a front cover 80 and a bottom plate 40. The front cover 80 disposed on a front surface of the display panel 10 may be a top cover. The front cover 80 has a square frame covering top and side surfaces of the display panel 10. A front surface of the front cover 80 may be opened to display an image realized on the display panel 10.

Also, the bottom plate 40 may be disposed on a rear surface of the backlight unit 20. The bottom plate 40 may be a bottom cover. The display panel 10 and the backlight unit 20 may be coupled to each other to perform a fundamental function of the display apparatus. Also, the bottom plate 40 may have a square plate shape.

A driving part 60 may be disposed on a surface of the bottom plate 40 disposed on the rear surface of the backlight unit 20. The driving part 60 includes a driving control unit 61, a main board 62, and a power supply unit 63. The driving control unit 61 may be a timing controller. That is, the driving control unit 61 may be a driving unit for adjusting operation timing of each driving circuit of the display panel 10. The main board 62 may be a driving unit for transmitting V-sync, H-sync, and R, G, B resolution signals into the timing controller. The power supply unit 63 may be a driving unit for applying a power into the display panel 10 and the backlight unit 20.

A driving part 60 may be disposed on a surface of the bottom plate 40 disposed on the rear surface of the backlight unit 20 by a chassis 50. Also, the driving part 60 may be surrounded by the rear surface case 70.

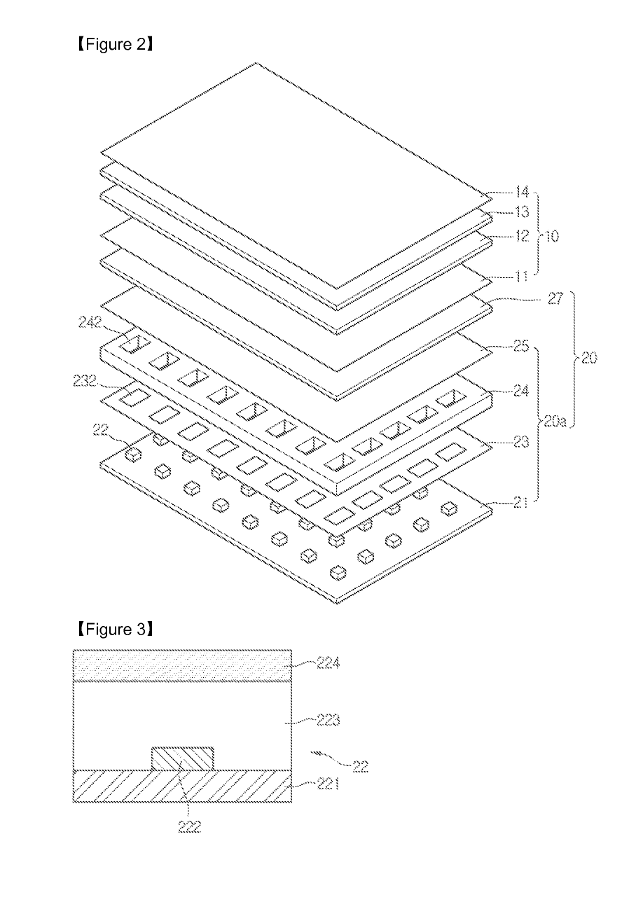

FIG. 2 is an exploded perspective view illustrating a display module of a display apparatus according to an embodiment.

Referring to FIG. 2, a display module according to an embodiment includes a display panel 10 and a backlight unit 20.

In detail, the display panel 10 includes a color filter substrate 13 and a thin film transistor substrate 12 which are attached facing each other to maintain a constant cell gap therebetween. A liquid crystal layer (not shown) may be disposed between the two substrates 13 and 12.

The color filter substrate 13 includes a plurality of pixels constituted by red R, green G, and blue B sub pixels. Also, the color filter substrate 13 may images corresponding to red, green, and blue colors when light is applied to the color filter substrate 13.

Although the pixels are constituted by the red, green, and blue sub pixels in the current embodiment, the present disclosure is not limited thereto. For example, the red, green, blue, and white W sub pixels may constitute one pixel or a combination thereof may constitute one pixel.

The TFT substrate 12 may function as a switching device to switch a pixel electrode (not shown). For example, a common electrode (not shown) and the pixel electrode may convert arrangement of molecules of the liquid crystal layer according to a predetermined voltage applied from the outside.

The liquid crystal layer includes a plurality of liquid crystal molecules. The liquid crystal molecules may be arranged corresponding to a voltage difference generated between the pixel electrode and the common electrode. Thus, light provided from the backlight unit 20 may be incident into the color filter substrate 13 to correspond to a variation of the molecule arrangement of the liquid crystal layer.

Also, the display panel 10 further includes a lower polarizer 11 disposed on a bottom surface of the TFT substrate 12 and an upper polarizer 14 seated on a top surface of the color filter substrate 13.

The backlight unit 20 may fixedly adhere to an under surface of the display panel, i.e., the lower polarizer 11. As described above, since the backlight unit 20 is closely attached to the display panel 10, the display module may be reduced in thickness. Also, since a structure for fixing the backlight unit 20 is removed, the display module may be simplified in structure and manufacturing process.

Also, since a space between the backlight unit 20 and the display panel is removed, it may prevent foreign substances from being introduced into the space. Thus, it may prevent the display module from being malfunctioned or image quality of the display apparatus from being deteriorated.

According to an embodiment, the backlight unit 20 may have a structure in which a plurality of functional layers are stacked with each other. Also, a plurality of light sources may be mounted on at least one layer of the plurality of functional layers.

Also, the plurality of layers constituting the backlight unit 20 may be formed of a flexible material to closely attach the backlight unit 20 to the under surface of the display panel. The backlight unit 20 may be directly attached to a front surface of a back cover defining a rear outer appearance of the display apparatus. Thus, the total thickness of the display device may be reduced to realize miniaturization of the display apparatus.

According to an embodiment, the display panel may be divided into a plurality of areas. A light source mounted on an area of the backlight unit 20 corresponding to each of the divided areas may be adjusted in brightness according to a gray peak value or color coordinate signal required in each of the divided areas to adjust brightness of the display panel. For this, the backlight unit 20 may be divided into a plurality of division driving areas respectively corresponding to the divided areas of the display panel to allow local dimming.

As described above, the backlight unit 20 includes an optical assembly 20a and an optical sheet 27. The optical assembly 20a includes a first layer 21, a plurality of light sources 22 mounted on a top surface of the first layer 21, a second layer 23 disposed on the top surface of the first layer 21, a light guide layer 24 disposed on a top surface of the second layer 23, and a light shield layer 25 disposed on a top surface of the light guide layer 24 to block a portion of light concentrated around the light source 22. Also, a hollow part 242 for receiving each of the light sources 22 is defined in the light guide layer 24.

Also, the optical sheet 27 may include a diffusion plate and/or a diffusion sheet which diffuse(s) light emitted from the light source to produce planar light and a prism sheet for collecting the light diffused from the diffusion sheet.

In detail, the first layer 21 may be a circuit board on which the plurality of light sources 22 are mounted. Also, an adaptor for supplying a power and an electrode pattern for connect the light sources 22 to each other may be disposed on the first layer 21. For example, a carbon nano tube electrode pattern for connecting the light sources 22 to the adaptor may be disposed on a top surface of the first layer 21.

Also, the first layer 21 may be a PCB formed of polyethylene terephthlate (PET), glass, polycarbonate (PC), or silicon (Si), on which the plurality of light sources 22 are mounted. Alternatively, the first layer 21 may be a flexible film type PCB.

The light source 22 may be one of an LED chip or an LED package including at least one LED chip. In the current embodiment, the LED package is exemplified as the light source 22.

The LED package constituting the light source 22 may be classified into a top view type LED package and a side view type LED package according to the direction of a light emitting surface. The top view type LED package which emits light upward will be exemplified as the light source 22.

The light source 22 may also be a color LED emitting at least one of red, blue, and green light, or a white LED. The color LED may include at least one of a red LED, a blue LED, and a green LED, and the arrangement and light emission type of the LEDs may be varied within the technical scope of the embodiment.

The light guide layer 24 may be disposed above the first layer 21 to surround the plurality of light sources 22. The light guide layer 24 may transmit light emitted from the light source 22 toward the display panel and also diffuse the light to uniformly provide the light emitted from the light source 22 to the display panel.

For example, the light guide layer 24 may be formed of a silicon- or acryl-based resin. However, the material of the light guide layer 24 is not limited thereto. For example, the light guide layer 24 may be formed of one of various resins. The light guide layer 24 may be formed of a resin having a refractive index of about 1.4 to 1.6 so that light emitted from the light source 22 is diffused to ensure the uniform brightness of the backlight unit 20.

For example, the light guide layer 24 may be formed of at least one selected from the group consisting of polyethyeleneterepthalate (PET), polycarbonate (PC), polypropylene (PP), polyethylene (PE), polystyrene (PS), polyepoxy (PE), silicone, and acrylic.

The light guide layer 2 may include an adhesive polymer resin so that the light guide layer 24 firmly adheres to the second layer 23. For example, the light guide layer 24 may include unsaturated polyester; an acrylic-based material such as methylmethacrylate, ethylmethacrylate, isobutyl methacrylate, normal butyl methacrylate, normal butyl methylmethacrylate, acrylic acid, methacrylic acid, hydroxyl ethylmethacrylate, hydroxyl propyl methacrylate, hydroxyl ethyl acrylate, acryl amide, methylol acryl amide, glycidyl methacrylate, ethyl acrylate, isobutyl acrylate, normal butyl acrylate, and 2-ethyl hexyl acrylate polymer, copolymer, or therpolymer; an urethane-based material; an epoxy-based material; and a melamine-based material.

The light guide layer 24 may be formed by coating a liquid or gel resin on the plurality of light sources 22 and the second layer 23 and curing the resin. Alternatively, the light guide layer 24 may be separately injection-molded to adhere to a top surface of the first layer 2.

Also, a plurality of dispersion particles may be provided in the light guide layer 24. In detail, the dispersion particles disperse and refract light emitted from the light sources 22 to more widely diffuse the light.

In detail, to disperse and reflect the light emitted from the light source 24, the dispersion particles may be formed of a material having a refractive index different from that of the material forming the light guiding layer 24, i.e., be formed of a material having a refractive index greater than that of a silicone-based or acrylic-based resin forming the light guiding layer 24.

For example, the dispersion particles may be formed of poly methyl methacrylate/styrene copolymer (MS), poly methyl metaacrylate (PMMA), poly styrene (PS), silicone, titanium dioxide (TiO2), silicon dioxide (SiO2), or a combination thereof.

The dispersion particles may be formed of a material having a refractive index lower than that of the material forming the light guide layer 24. For example, bubbles may be formed within the light guide layer 24 to form the dispersion particles. Here, the material forming the dispersion particles is not limited to the above-described materials. For example, the dispersion particles may be formed using various polymer or inorganic particles.

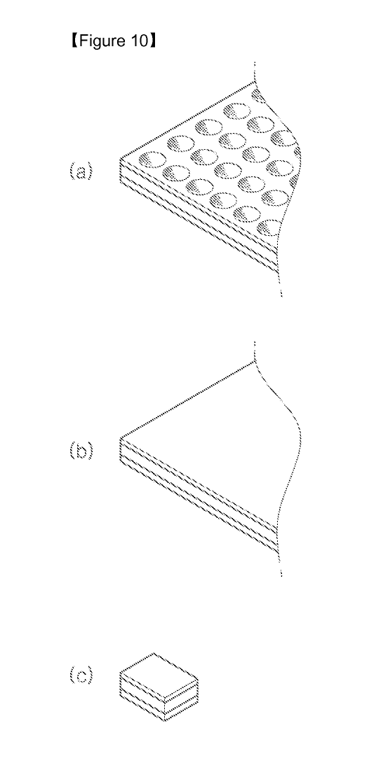

The second layer 23 is disposed between the first layer 21 and the light guide layer 24. The second layer 23 is a layer for extracting or reflecting the light emitted from the light source 22 toward the display panel. Thus, the second layer 23 may be referred to as a light extraction layer or reflection layer. A light extraction pattern (see reference numeral 231 of FIG. 10) may be disposed on a top surface of the second layer 23 to effectively extract the bumping light emitted from the light source 22 toward the display panel. The light extraction pattern 231 may be referred to as a diffusion pattern because the light extraction pattern 231 diffuses the light emitted from the light source 22 up to the adjacent light source at uniform brightness.

The light extraction pattern 231 may be formed of at least one of a metal or metal oxide that is a reflective material. For example, the light extraction pattern 231 may be formed of a metal or metal oxide having high reflectivity such as aluminum (Al), silver (Ag), gold (Au), or titanium dioxide (TiO₂). In this case, the light extraction pattern 231 may be formed by depositing or coating the metal or metal oxide on the second layer 23. Alternatively, the light extraction pattern 231 may be formed by printing metal ink.

Also, the second layer 23 may be a sheet in which a white pigment such as titanium oxide is dispersed among sheets formed of a synthetic resin material, a sheet in which a metal deposition layer is stacked on a surface thereof, or a sheet in which bubbles are dispersed to scatter light among the sheets of the synthetic resin material. Also, to increase the reflectivity, Ag may be coated on a surface of the second layer 23. The second layer 23 may be directly coated on the top surface of the first layer.

Also, a light source hole 232 through which the light source passes is defined in the second layer 23 to prevent the light source 22 and the second layer 23 from interfering with each other.

Hereinafter, in the application of the top view type LED package, an LED package structure having improved lateral orientation and a surface light source structure using the same will be described in detail with reference to the accompanying drawings.

FIG. 3 is a sectional view of a light source according to a first embodiment.

Referring to FIG. 3, the light source 22 according to the current embodiment includes a light source 22, a sub mount substrate 221, an LED chip 222 mounted on the sub mount substrate 221, a resin layer 223 disposed above a top surface of the sub mount substrate 221 to cover the LED chip 222, and a transmittance adjustment layer 224 seated on a top surface of the resin layer 223.

In detail, the resin layer 223 may be formed of a transparent resin material such as silicon or a transparent material containing a phosphor. Specifically, when the resin layer 223 is formed of a pure transparent material, light having the same color as that of light emitted from the LED chip 222 is irradiated toward a display panel. Also, when the resin layer 223 is formed do the transparent material containing the phosphor, the light emitted from the LED chip 222 may bump against the phosphor to convert the light into white light. For example, to realize a white LED by grafting a blue LED onto the phosphor, a portion of blue light emitted from the blue LED using a yellow phosphor is absorbed into the yellow phosphor to excite the phosphor. The excited phosphor may emit yellowish light having a wide wavelength, and then blue light which is not absorbed into the phosphor may be mixed with the yellowish light to realize white light.

The transmittance adjustment layer 224 may transmit a portion of the light emitted from the LED chip 222 and laterally reflect the remaining light except the transmitted light. Since the top view type light source is provided as the light source 22 according to the current embodiment, the most of light emitted from the LED chip 222 may proceed upward. Thus, since light density around the light source 22 is high, a hot spot phenomenon in which the surrounding of the light source 22 is excessively bright than those of other areas may occur. To minimize the hot spot phenomenon and realize uniform brightness of the backlight unit 20, the transmittance adjustment layer 224 is disposed on a top surface of the LED chip 222.

The transmittance adjustment layer 224 may be formed of a material containing diffusion particles to adjust the amount of upwardly transmitting light. Here, the amount of transmitting light may be adjusted according to kind, size, and amount of the diffusion particles and a shape of a bottom surface of the transmittance adjustment layer 224.

The transmittance adjustment layer 224 may perform a light shield function equal to a function of the light shield layer 25, which blocks a portion of light emitted toward the display panel. The light transmittance adjustment layer 224 may be formed of TiO₂ or white ink.

FIG. 4 is a sectional view of a light source according to a second embodiment.

Referring to FIG. 4, a light source 22 according to the current embodiment has the same structure as that of the light source 22 according to the first embodiment except that an interface between an a transmittance adjustment layer 224 and a resin layer 223 is inclined.

In detail, since a bottom surface 223a of the transmittance adjustment layer 224 is inclined, a portion of light is refracted, another portion of the light is fresnel-reflected, and the other portion is totally reflected.

Since the resin layer 223 and the transmittance adjustment layer 224 have refractive indexes different from each other, light may be refracted and totally reflected by the interface. Thus, when light incident into the inclined surface 223a is incident at an angle less than a critical angle, a portion of the light may transmit the transmittance adjustment layer 224 and the other portion of the light may be laterally diffused. The light incident at an angle greater than the critical angle may be totally reflected and laterally diffused. Due to the refraction and total reflection effects, the light emitted from the LED chip 222 may be adjusted in transmittance.

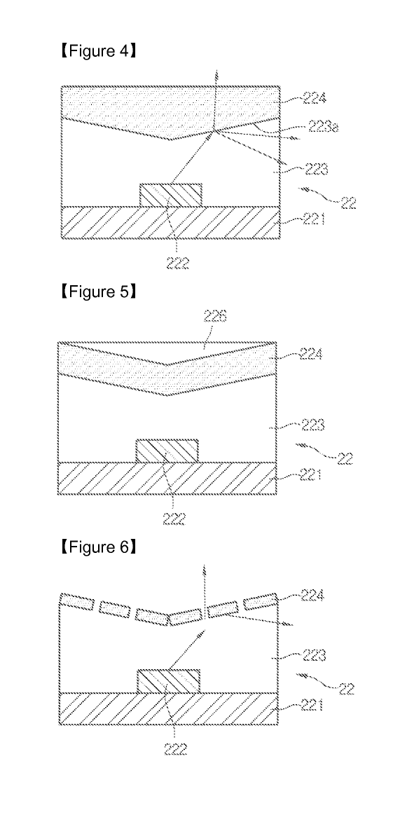

FIG. 5 is a sectional view of a light source according to a third embodiment.

Referring to FIG. 5, a light source 22 according to the current embodiment has the same structure as that of the light source 22 according to the second embodiment except that a transmittance adjustment layer 224 has a uniform thickness and a transparent layer 226 defined in a top surface of the transmittance adjustment layer 224 is filled.

When the transmittance adjustment layer 224 has an inclined bottom surface and a uniform thickness, a groove may be defined in the top surface of the transmittance adjustment layer 224. A transparent adhesive or resin may be filled into the groove to realize a flat top surface of the light source 22.

FIG. 6 is a sectional view of a light source according to a fourth embodiment.

Referring to FIG. 6, a light source 22 according to the current embodiment has the same structure as that of the light source 22 according to the third embodiment in that a transmittance adjustment layer 224 is inclined except that the light transmittance adjustment layer 224 has a pattern structure in which a plurality of openings are defined to adjust light transmittance.

In detail, the plurality of openings for transmitting light are defined in the light transmittance layer 224. Thus, a ratio of the transmittance adjustment layer 224 to the entire area, i.e., an opening ratio may be adjusted to adjust the amount of white light transmitting the transmittance adjustment layer 224. Here, diffusion particles may be contained in the transmittance adjustment layer 224. Alternatively, the transmittance adjustment layer 224 may be formed of a metal layer which can reflect light. Alternatively, a dielectric may be coated on the transmittance adjustment layer 224 to adjust a reflective index of the light.

In more detail, the transmittance adjustment layer 224 may have the openings defined in a portion of a layer containing the diffusion particles. In addition, as described above, the transmittance adjustment layer 224 may be formed of a film sheet, and a metal layer formed of Ag or Al may be coated on a reflective surface of the sheet. In this case, a portion of the sheet may be not coated to transmit light. Through the same method as the above-described method, a portion through which light is transmitted, i.e., an area corresponding to the opening may be coated with the dielectric to improve transmittance of the incident light. Since the light reflected by the transmittance adjustment layer 224 is reflected again by the dielectric on the portion on which the dielectric coating process is performed, the transmittance may be improved. This may be the same principle as that of a non-reflection coating lens in which a dielectric coating process is performed on a surface thereof to improve transmittance.

Like the third embodiment, the groove defined in the top surface of the transmittance adjustment layer 24 may be filled with a transparent adhesive or resin.

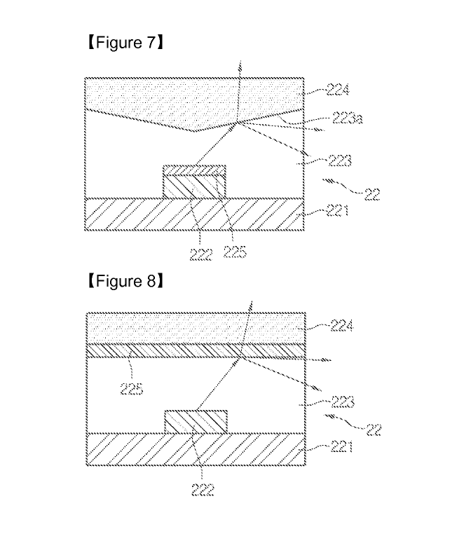

FIG. 7 is a sectional view of a light source according to a fifth embodiment.

Referring to FIG. 7, the current embodiment has the same structure as that of the second embodiment except that a phosphor layer is disposed on a top surface of an LED chip 222.

In case of the first to fourth embodiments, the resin layer 223 is a layer formed of a mixture of the transparent resin material and the fluorescent material. However, in case of the current embodiment, a fluorescent material is not mixed with a resin layer 223. A phosphor layer 225 formed of only a fluorescent material is seated on a light emitting surface of an LED chip 222. That is, the resin layer 223 is formed of only a transparent resin material.

As a result, light emitted from the LED chip 222 may be converted into white light while being directly bumped against the phosphor layer 225. Then, the converted white light may be diffused inside the resin layer 223. Also, the light diffused into the resin layer 223 may be refracted and totally reflected by an interface 223a between the resin layer 223 and a transmittance adjustment layer 224 to partially transmit or reflect the light.

FIG. 8 is a sectional view of a light source according to a sixth embodiment.

Referring to FIG. 8, the current embodiment is equal to the fifth embodiment in that a resin layer 223 and a phosphor layer 225 are independently formed except that the phosphor layer 225 is disposed between a transmittance adjustment layer 224 and the resin layer 223.

In detail, color light emitted from an LED chip 222 passes through the resin layer 223 formed of a transparent material and then is incident into the phosphor 225. The color light incident into the phosphor layer 225 is converted into white light by exciting the fluorescent material. The converted white light may be partially refracted and reflected a bottom surface of the transmittance adjustment layer 224 or totally reflected to adjust the amount of transmitting light.

As shown in FIG. 8, an outer edge of the resin layer 223 may be surrounded by the phosphor layer 225 except that a flat phosphor layer 225 is disposed on the bottom surface of the transmittance adjustment layer 224. Also, as shown in FIG. 4, the phosphor layer 225 may be applied to a structure in which the transmittance adjustment layer 224 has an inclined bottom surface.

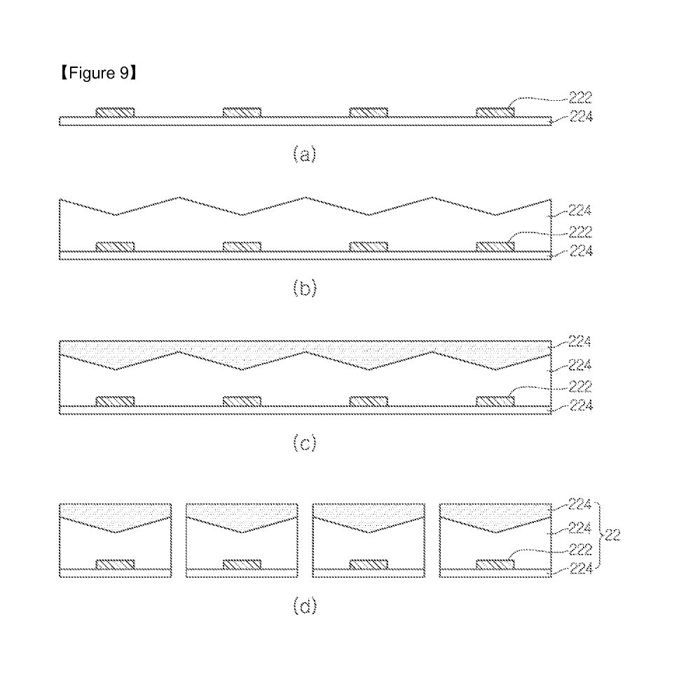

FIG. 9 is a view illustrating a process of manufacturing a light source according to an embodiment.

Referring to FIG. 9, a light source 22 according to an embodiment, i.e., an LED package may be manufactured through following processes. Hereinafter, a process of manufacturing the light source according to the second embodiment of FIG. 4 will be described as an example.

In detail, as shown in FIG. 9A, a substrate module on which an LED chip 222 is mounted on a sub mount 221 is prepared. A resin layer 223 pours onto a top surface of the substrate module to cure the resin layer 223. The resin layer 223 may be a layer in which a transparent resin material and a fluorescent material are mixed with each other.

When the resin layer 223 is completely cured, a material for forming a transmittance adjustment layer 224 may pure onto a top surface of the resin layer 223 to cure the material for forming the transmittance adjustment layer 224. After the transmittance adjustment layer 224 is completely cured, the transmittance adjustment layer 224 is cut by an LED chip unit to manufacture one LED package.

FIG. 10 is a perspective view illustrating outer appearances of an LED package substrate and an LED package which are manufactured in the process of manufacturing the light source in FIG. 9.

Referring to FIG. 10, a shape of the substrate illustrated in FIG. 10A shows a state after a process of FIG. 9B is completely performed. That is, a top surface of the resin layer 223 is recessed, and the recessed portion has a width gradually decreasing toward a bottom. Here, the recessed portion may have a circular shape or a polygonal shape in section.

Also, a shape of the substrate illustrated in FIG. 9B shows a state after a process of FIG. 9C is completely performed. That is, the recessed portion is filled with the transmittance adjustment layer 224 to form a substrate having a flat top surface.

Also, FIG. 10C is a perspective view of an LED package after the cutting process is completely performed. As described above, the LED package is mounted on a first layer 21 of a backlight unit 20.

FIG. 11 is a sectional view of a display module on which a light source is mounted according to an embodiment.

Referring to FIG. 11, the light source 22 described in the first to sixth embodiments, i.e., the LED package is mounted on a first layer 21 of a backlight unit 20. Then, a second layer 23 and a light guide layer 24 are disposed on the LED package. Also, a light shield layer 25 is disposed on a top surface of the light guide layer 24.

Also, an optical sheet 27, a lower polarizer 11, a TFT substrate 12, a color filter substrate 13, and an upper polarizer 14 are successively seated on a top surface of the light shield layer 25 to form one display module.

Here, light sources 22 are received into a plurality of hollow parts 242 defined in the light guide layer 24, respectively. Also, light emitted from the light sources 22 may be transmitted toward a display panel or diffused and moved into the light guide layer 24 to form a planar light source.

In detail, a portion of light emitted upward from the LED chip 222 passes through the transmittance adjustment layer 224 and then is moved toward the display panel. Also, the other portion of the light is reflected by the transmittance adjustment layer 224 and then diffused into the light guide layer 24. The light diffused into the light guide layer 24 bumps against diffusion particles existing within the light guide layer 24 and thus is diffused and reflected in various directions. A portion of light incident into the light guide layer 24 bumps against the second layer 23 and thus is reflected again. Then, the reflected light proceeds toward the display panel.

Also, a portion of light incident into the second layer 23 bumps against a light extraction pattern 231 disposed on the second layer 23 and thus is diffused in various directions. Through the diffusion and re-reflection process, the backlight unit 20 may have uniform brightness.

A light shield pattern may be disposed on the light shield layer 25 disposed on the top surface of the light guide layer 24 to minimize a hot spot phenomenon. That is, since a lot of light emitted from the light sources 22 is concentrated into an edge portion of each of the hollow part 242, the light shield pattern 251 may be disposed on the edge portion. A portion of the light incident into the light shield pattern 251 may be reflected again into the light guide layer 24, and only a portion of the light may be transmitted and moved toward the display panel to minimize the hot spot phenomenon.

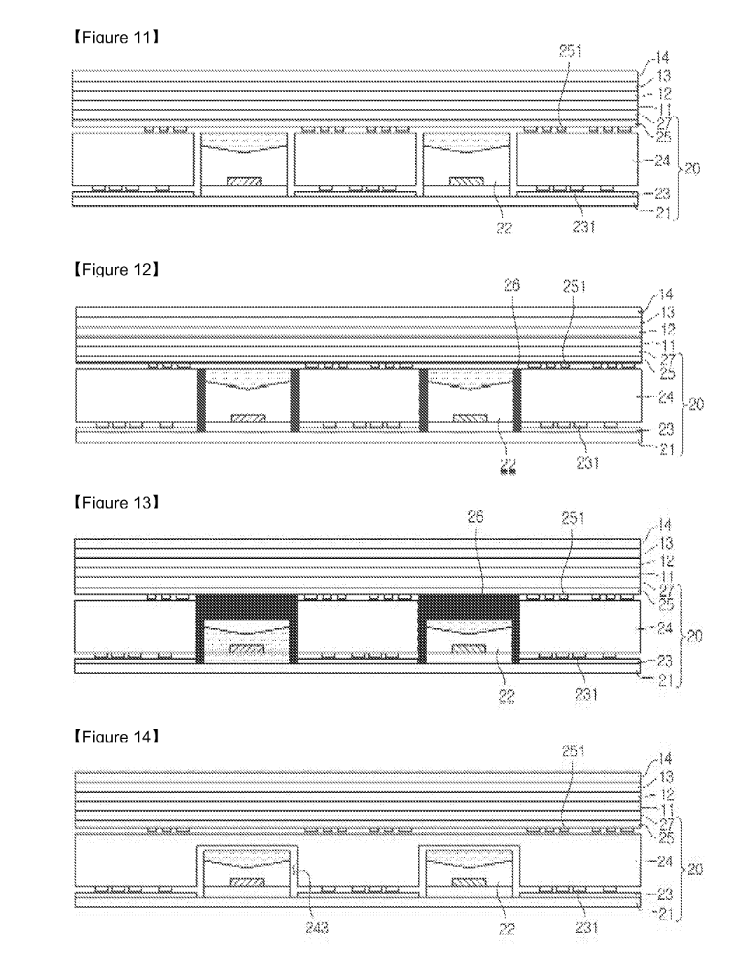

FIG. 12 is a sectional view of a display module according to another embodiment.

Referring to FIG. 12, a spaced space is defined between the light source 22 and the hollow part 242 of the light guide layer 24.

In detail, an adhesion part 26 formed of a transparent adhesion material may be disposed in the spaced space to improve a coupling force between the light guide layer 24 and the light source 22 and furthermore improve optical functions.

In the current embodiment, a top surface of the light source 22 may be flush with that of the light guide layer 24. Also, the adhesion part 26 may surround a side surface of the light source 22.

FIG. 13 is a sectional view of a display module according to another embodiment.

Referring to FIG. 13, a display module according to the current embodiment has the same structure of that of the display module of FIG. 12. An adhesion part 26 is filled into a spaced space between a hollow part 242 and a light source 22.

However, in the current embodiment, the light source 22 has a height less than that of a light guide layer 24. Also, the adhesion part 26 surrounds all of side and top surfaces of the light source 22.

FIG. 14 is a sectional view of a display module according to another embodiment.

Referring to FIG. 14, a display module according to the current embodiment is different from those according to the foregoing embodiments in that a groove 243 for receiving a light source 22 is defined in a light guide layer 24.

In detail, in the foregoing embodiments, the plurality of hollow parts 242 are defined in the light guide layer 24 to receive the light sources 20, respectively. However, in the current embodiment, the light guide layer 24 has a continuously flat top surface. Also, a groove 243 having a depth corresponding to a height of the light source 22 from a bottom surface is defined.

Also, a spaced space may be defined between the groove 243 and the light source 22. Also, an adhesion part 26 may be filled into the spaced space.

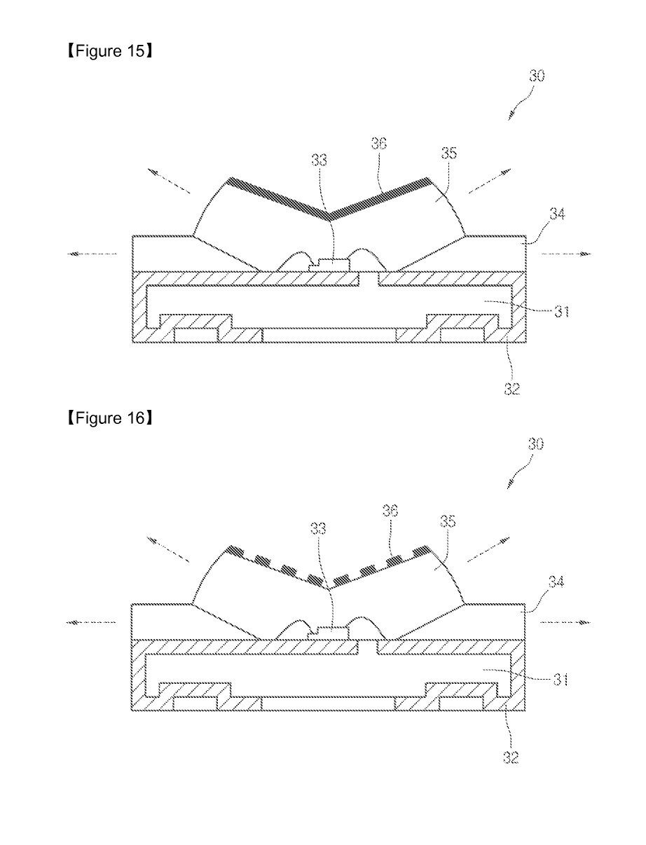

FIG. 15 is a sectional view of a light source according to a seventh embodiment.

Referring to FIG. 15, a light source 30 according to the current embodiment includes a sub mount substrate 31 on which a lead frame 32 is mounted, an LED chip 33 mounted on the sub mount substrate 31 and electrically connected to the lead frame 32, a resin layer 34 in which a recessed portion (or cavity) is defined in a top surface thereof, a lens 35 for adjusting characteristics of light emitted from the LED chip 33, and a transmittance adjustment layer 36 disposed on a top surface of the lens 35 to laterally reflect the light emitted from the LED chip 33.

In detail, the transmittance adjustment layer 36 may have the same structure as the above-described transmittance adjustment layer. Also, a top surface of the lens 35 on which the transmittance adjustment layer 36 is disposed may have one of a shape recessed at a predetermined depth, a flat cut shape, a convex lens shape. Also, a method for forming the transmittance adjustment layer 36 on the top surface of the lens 35 and a function of the transmittance adjustment layer 36 may be substantially equal to those according to the foregoing embodiments. Thus, the transmittance adjustment layer 36 may be provided to disperse a portion of light emitted onto a top surface of the backlight unit 20 in an axis direction, thereby realize uniform brightness and minimizing a hot spot phenomenon.

FIG. 16 is a sectional view of a light source according to an eighth embodiment.

Referring to FIG. 16, a light source according to the current embodiment has the same structure as that of the light source 30 of FIG. 15 except that a transmittance adjustment layer 36 has a pattern structure in which a plurality of openings are defined as shown in FIG. 6.

In detail, when the transmittance adjustment layer 36 has the pattern structure in which the plurality of opens are defined, only a portion of light emitted from an LED chip 33 may transmit the transmittance adjustment layer 36 to improve brightness uniformity of a backlight unit 20.

Hereinafter, according to the current embodiment, provided is a light source in which a phosphor is not provided therein, i.e., in a lens 35 covering an LED chip 33.

In detail, the phosphor is a material which bumps against light emitted from the LED chip 33 to produce white light. For example, when the light emitted from the LED chip 33 has a blue wavelength, the phosphor may have a yellow color.

In the following embodiment, a phosphor used in an existing LED light source or a quantum dot may be used as the phosphor. Also, a color conversion layer containing the phosphor may be separately provided. Thus, a backlight structure in which white light is produced outside the light source 30 will be described.

The quantum dot may be one of nano materials which are highlighted in recent years. The quantum dot includes a core having a size of about 2 nm to about 10 nm and a shell formed of ZnS. Here, since a polymer is coated on an outer surface of the shell, the quantum dot may have a nano particle size of about 10 nm to about 15 nm. The core of the quantum dot may be formed of CdSe, CdTe, or CdS.

The quantum dot may produce a strong phosphor in a narrow wavelength. And, light emitted from the quantum dot is emitted by exciting electrons from a conduction band to a valance band. Here, the more the quantum dot has a small particle size, the more the produced phosphor emits light having a short wavelength. On the other hand, the more the quantum dot has a large particle size, the more the phosphor emits light having a long wavelength. Thus, the quantum dot may be adjusted in size to emit light visible light having a desired wavelength. Also, when quantum dots having various sizes are provided together with each other, light having various colors may be emitted even though light having one wavelength is emitted.

The quantum dot is being highlighted as a material which can supplement limitations of the LED that is in the spotlight as the light source of the next generation. Although the LED emits light having a single color such as white, red, green, or blue color according to a kind of device, the LED has low yield except for a white LED. However, in case of the quantum dot, since a desired natural color can be realized using a material itself, color gamut and brightness may be good when compared to the LED.

A reason in which the quantum dot is used as a fluorescent material for a single color LED package is because the quantum dot has high color purity, self-illumination characteristics, easy color balancing due to size adjustment, and allowable solution process. Also, since the quantum dot has the high color gamut, the quantum dot may be applied to a large-area high-quality display apparatus.

FIG. 17 is a sectional view of a display module according to another embodiment.

Referring to FIG. 17, a display module 10 according to the current embodiment uses the light source 30 of FIG. 15 or 16 as a light emitting device. Also, a light guide layer 24a is provided as an air layer, and a phosphor is disposed outside the light source 30.

In detail, the display module 10 includes a first layer 21, a second layer 23 disposed on a top surface of the first layer 21, a light source 30 seated on the second layer 23, the light guide layer 24a disposed above the second layer 23 and filled with air, an optical sheet 27 disposed on a boundary of a top surface of the light guide layer 24a and including a diffusion sheet, a light conversion layer 28 coupled to a bottom surface of the optical sheet 27, and a display panel 10 disposed on a top surface of the optical sheet 27. Also, as described above, the display panel 10 includes a color filter substrate 13, a TFT substrate 12, and upper and lower polarizers 14 and 11.

Also, the color conversion layer 28 may be a layer formed of a fluorescent material covering the surrounding of an existing LED chip. As described above, in case where a blue LED is applied, if a color conversion layer formed of a yellow fluorescent material is applied, white light may be emitted finally.

The color conversion layer 28 may be a fluorescent sheet formed of a phosphor used in the existing LED package or a fluorescent sheet formed of the quantum dot. Also, the color conversion layer 28 may be attached to the bottom surface of the optical sheet 27. Thus, light having a single wavelength emitted from the light source 30 may bump against the color conversion layer 28 to convert the light into white light. Also, the white light passes through the optical sheet 27 and then is emitted toward the display panel 27.

Since the light guide layer 24a is provided as the air layer, total reflection due to a refractive index difference occurring on an interface between two materials different from each other does not occur. Thus, color limitations due to the total reflection do not occur. Furthermore, the light guide layer may be formed of a resin material to reduce a weight of a backlight unit 20 by a corresponding weight of the light guide layer. Also, since the light guide layer 24a having the air is applied, light emitted from the light source 30 and reflected toward a transmittance adjustment layer 36 may be increased in light guide distance.

Also, since the color conversion layer 28 is disposed on a position spaced from the LED chip 33, light extraction efficiency may be improved. That is, when the phosphor layer 342 is spaced from a light emitting chip 33, the number of total reflection and dispersion may be reduced and also light loss may be reduced. In case of the existing LED package, the phosphor layer may directly surround the LED chip to cause a phenomenon in which a portion of light emitted from the LED chip is re-reflected into the LED chip by the phosphor layer to cause absorption loss. However, according to the current embodiment, since he color conversion layer 28 is spaced from the LED chip 22, light loss within the light source 30 may be significantly reduced.

FIG. 18 is a sectional view of a display module according to another embodiment.

Referring to FIG. 18, most of parts has the same structure as those of FIG. 17 except a structure of a phosphor layer.

In detail, an optical sheet 27a in which a phosphor is mixed may also perform a function of a color conversion layer. Thus, it may be unnecessary to attach a separate phosphor sheet to the optical sheet 27a. Also, an adhesive for attaching the color conversion layer to an optical sheet 27a may be unnecessary. Also, light emitted from a light source 30 may bump against the phosphor in an optical sheet 27a and be converted into white light. Then, the white light may proceed toward a display panel 10.

FIG. 19 is a sectional view of a display module according to another embodiment.

Referring to FIG. 19, in a display module according to the current embodiment, a light shield layer 25 is disposed on a top surface of a light guide layer 24a provided as an air layer. Also, a color conversion layer 28 is disposed between the light shield layer 25 and an optical sheet 27.

In detail, light emitted from the light source 30 may be re-reflected to the light guide layer 24a by a light shield pattern 251 disposed on the light shield layer 25 to minimize hot spot and increase bumping of color light into the color conversion layer 28. Thus, the hot spot may be minimized to maximize bright uniformity.

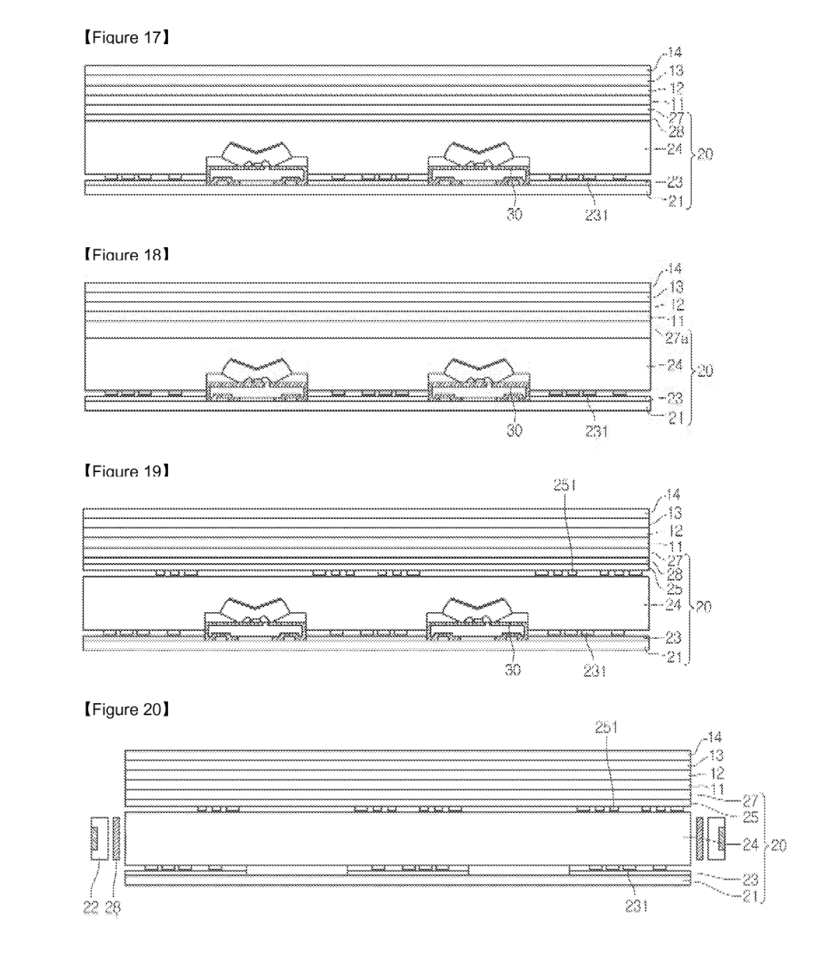

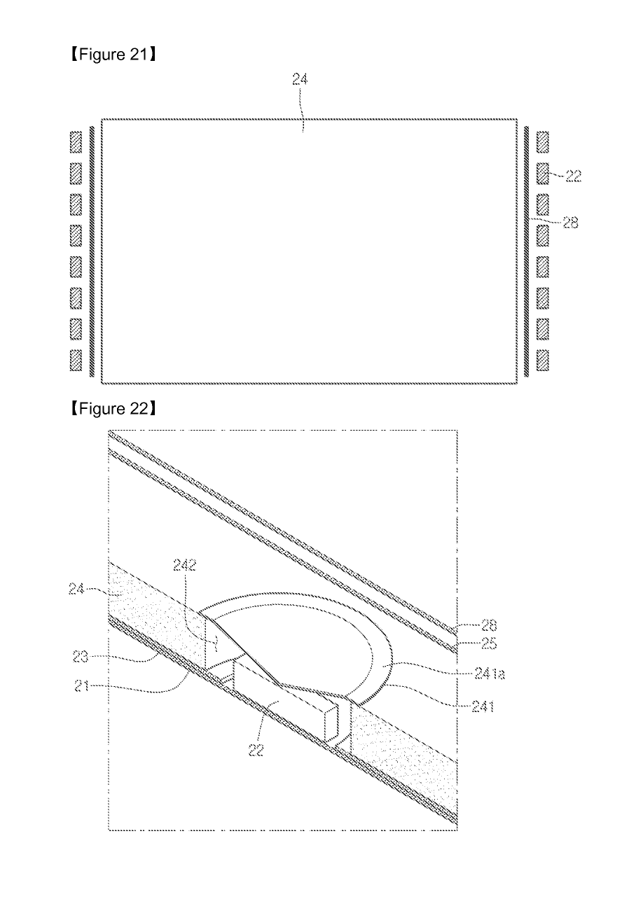

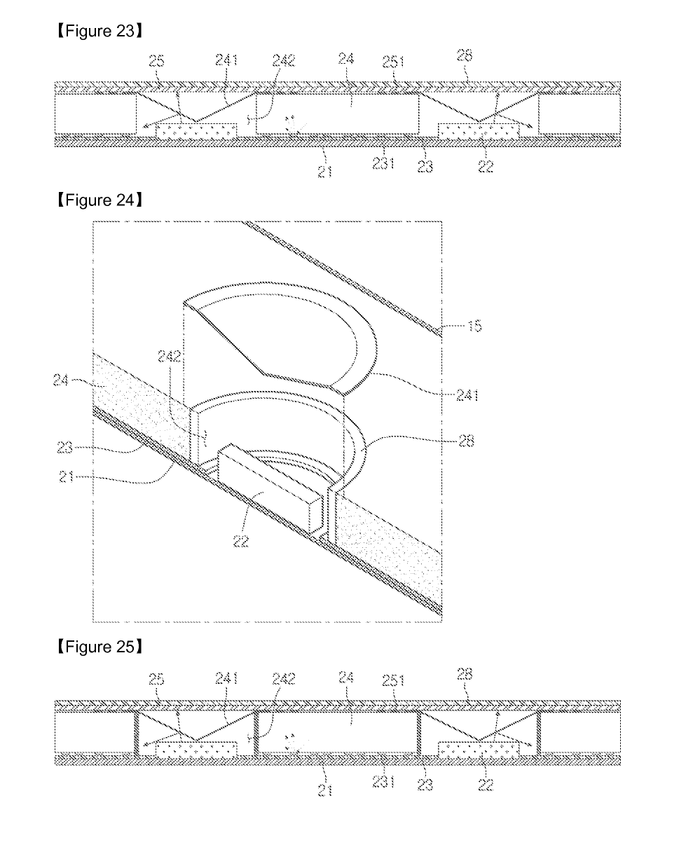

FIG. 20 is a sectional view of a display module according to another embodiment. FIG. 21 is a plan view of the display module.

Referring to FIGS. 20 and 21, a display module according to the current embodiment includes a light guide layer 24 formed of a transparent resin material, a plurality of light sources 22 arranged along one surface or both side surfaces of the light guide layer 24, a color conversion layer 28 disposed on light emission surfaces of the light sources 22, a light shield layer 25 disposed on a top surface of the light guide layer 24, an optical sheet 27, and a display panel 10.

In detail, a display module according to the current embodiment is an edge type module in which the light sources 22 are disposed on a side surface of a backlight unit 20. Also, the color conversion layer 28 is disposed on the light emission surfaces of the light sources 22. Also, each of the light sources 22 does not contain a phosphor in which single color light emitted from the LED chip is converted into white light.

In a display module structure according to the current embodiment, the light emitted from the light source 22 bumps against the color conversion layer 26 and thus is converted into white color. Then, the white color is incident into the light guide layer 24. Thus, the display module may obtain the same effect as that of the display module in which the light source containing the phosphor is mounted.

FIG. 22 is a partially cut-away perspective view of a display module according to another embodiment. FIG. 23 is a sectional view of the display module.

Referring to FIGS. 22 and 23, a hollow part 242 for receiving each of light sources 22 is defined in a light guide layer 24 of a display module according to the current embodiment. Also, a reflective sheet 241 is seated on the hollow part 242. A punching process may be performed on a light guide layer 24 manufactured through a separate injection molding process to form the hollow part 242. Alternatively, a resin may be directly molded on a top surface of a second layer 23 to form the hollow part 242.

In detail, the reflective sheet 242 may transmit a portion of light emitted directly upward from a top vie type light source 22 and reflect a portion of the light, like the transmittance adjustment layers 224 and 36. When the whole light emitted from the light source 22 is transmitted toward the display panel, a light density may be concentrated into an area adjacent to the light source 22 to cause hot spot. To solve this limitation, the reflective sheet 241 may be disposed above the light source 22. Thus, light emitted upward from the light source 22 may be laterally reflected to induce light diffusion within the light guide layer 24. As a result, light having uniform brightness may be emitted from the backlight unit 20.

The reflective sheet 241 may be formed of a material which transmits a portion of the light emitted from the light source 22 to proceed toward a display panel and reflects the other portion of the light to diffuse the light into the light guide layer 24. If the light emitted from the light source 22 is totally reflected, dark spots may be generated on an area on which the light source 22 is disposed. Accordingly, a portion of the light may be transmitted to maintain uniform brightness with that of the surrounding area.

For example, to effectively reflect and transmit the light emitted from the light source 22, Ag or Al which has a high reflectivity may be coated on a potion of the reflective sheet 241. The reflective sheet d241 may be formed of the same material as a light extraction pattern 231. Alternatively, the same material as the light extraction pattern 231 may be attached to a surface of a thin film.

Also, as shown in FIGS. 22 and 23, the reflective sheet 241 may have a width gradually decreasing downward toward the light source 22. This is done because the light emitted from the light source 22 is incident into the reflective sheet 241 and laterally reflected. Also, the reflective sheet 241 may have an inverted triangle shape in section. Also, the reflective sheet 241 may have a trapezoid shape which is parallelly cut at any lower position. A hook end 241a extending toward a side direction (a radius direction) from an upper end of the reflective sheet 241 may be hooked on an edge of a hollow part 242. Thus, the reflective sheet 241 may be stably coupled to the light guide layer 24.

A light shield layer 25 may be disposed on a top surface of the light guide layer 24. Also, a color conversion layer 28 may be attached to a top surface of the light shield layer 25 in a sheet form or coated on the top surface of the light shield layer 25.

FIG. 24 is a partially cut-away perspective view of a display module according to another embodiment. FIG. 25 is a sectional view of the display module.

Referring to FIGS. 24 and 25, a display module according to the current embodiment has the same structure as those of the display module of FIGS. 22 and 23 except that a color conversion layer 28 is disposed on a hollow part in a ring shape.

In detail, the color conversion layer 28 may have a ring-shaped or cylindrical sheet having a predetermined diameter. Thus, the color conversion layer 28 may be disposed on the hollow part 242 to surround an outer circumference of a light source 22. Also, a reflective sheet 242 may be disposed on an upper opening surface of the color conversion layer 28.

Through the above-described structure, single color light emitted from the light source 22 may be reflected by the reflective sheet 242 to bump against the color conversion layer 28. Then, the light bumping against the color conversion layer 28 may be converted into white light and incident into a light guide layer 24. The light incident into the light guide layer 24 may bump against a light extraction pattern 231 disposed on a second layer 23 and a light shield pattern 251 disposed on a light shield layer 25 and thus be reflected and refracted. Also, the light within the light guide layer 24 passes through the light shield layer 25 to proceed toward a display panel 10.

When a quantum dot phosphor is applied as a phosphor forming the color conversion layer, color gamut may be more improved when compared to that of the existing phosphor. Thus, a light emitting spectrum of the quantum dot phosphor may have a narrow width to expand a color gamut area. This may be confirmed through following graphs.

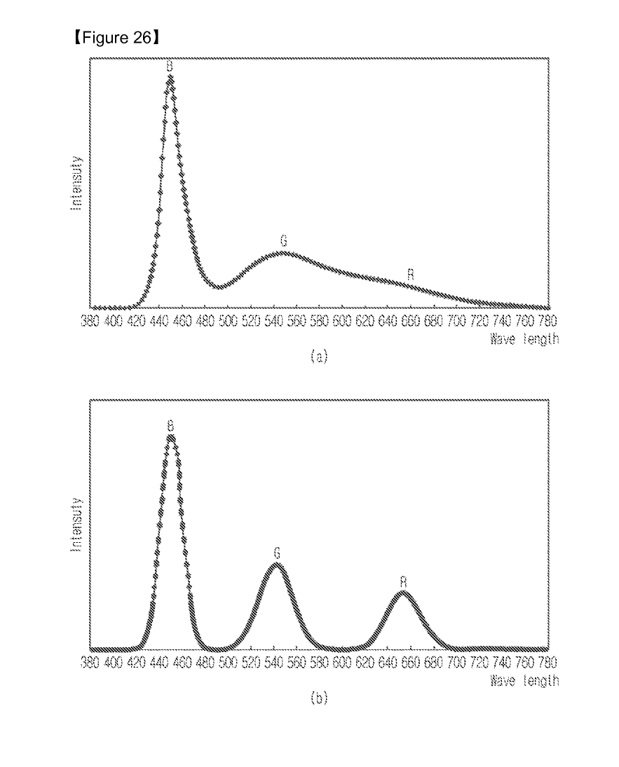

FIG. 26 is a view illustrating a light source spectrum of a backlight unit.

Referring to FIG. 26, a graph (a) shows a light source spectrum of a backlight unit to which an existing LED chip is applied. A graph (b) shows a light source spectrum of a backlight unit to which a quantum dot phosphor is applied to a color conversion layer.

Referring to the graph (b), it may be seen that blue (B), green (G), and red (R) spectrums is clearly classified and a half bandwidth is narrow when compared to that of the existing LED. In detail, the half bandwidth represents a mean value of a half of a maximum bandwidth of a light emitting spectrum. Thus, the more the half bandwidth is decreased, the more a difference with human color sensation is reduced. Also, the more the half bandwidth becomes narrow, the more the color gamut may be improved.

Referring to the graph (b), in case where the quantum dot is applied as the color conversion layer, a half bandwidth of a fluorescence spectrum is narrow when compared to that of the existing LED. Thus, the color gamut may be improved. That is, there may be advantageous that a wide color region is realized.

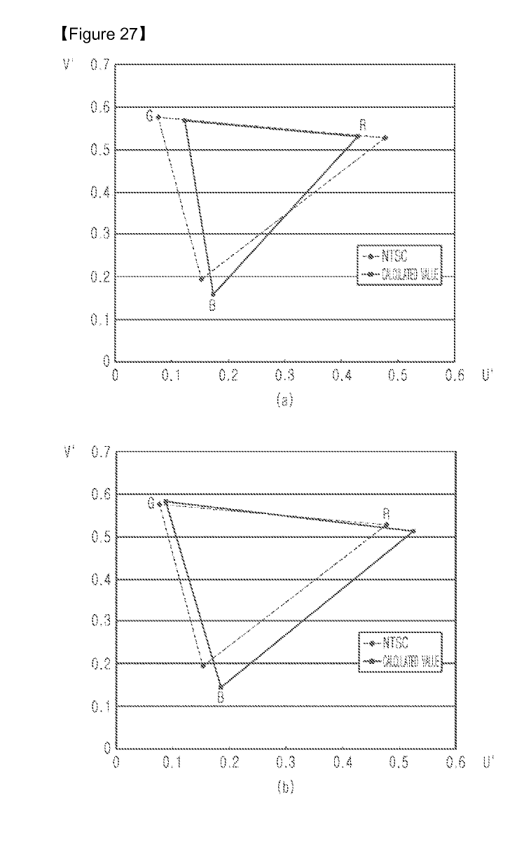

FIG. 27 is a view illustrating R, G, and B color coordinates used as a light source for a backlight unit.

Referring to FIG. 27, the graph shows a color coordinate in 1976. That is, the graph shows a color gamut range in comparison to a national television system committee (NTSC).

In detail, the graph (a) shows color gamut in case where the existing LED is applied, and the graph (b) shows color gamut of the LED to which the quantum dot is applied.

Here, an area of the graph represents a color gamut range. As shown in the graph, it may be confirmed that the color gamut range may be widened when the LED to which the quantum dot having a narrow half bandwidth is applied is used. That is, it may be seen that the color expression range is widened as the half bandwidth becomes narrow.

1. A display apparatus comprising:
a display panel; and
a backlight unit comprising a light source disposed at a rear side of the display panel to provide light,
wherein the light source comprises:
a sub mount substrate;
a light emitting chip mounted on a top surface of the sub mount substrate;
a resin layer disposed on the top surface of the sub mount substrate to surround the light emitting chip; and
a transmittance adjustment layer disposed on a top surface of the resin layer to adjust a transmitting rate of light emitted from the light emitting chip.

2. The display apparatus of claim 1, wherein the light emitting chip comprises an LED chip emitting color or white light.

3. The display apparatus of claim 1, wherein the resin layer is a layer formed of a transparent resin material.

4. The display apparatus of claim 3, further comprising a fluorescent layer disposed on a top surface of the light emitting chip.

5. The display apparatus of claim 3, further comprising a fluorescent layer disposed on a boundary between at least the resin layer and the transmittance adjustment layer.

6. The display apparatus of claim 1, wherein the resin layer is a layer in which a transparent resin material and a fluorescent material are mixed with each other.

7. The display apparatus of claim 1, wherein the transmittance adjustment layer is formed of a material which transmits only a portion of the light emitted from the light emitting chip, and
the transmittance adjustment layer is formed of at least silicon oxide or white ink.

8. The display apparatus of claim 1, wherein the transmittance adjustment layer has a pattern structure in which a portion of the light emitted from the light emitting chip is transmitted and the other portion is reflected.

9. The display apparatus of claim 8, wherein a diffusion particle is provided within the transmittance adjustment layer.

10. The display apparatus of claim 8, wherein at least metal layer formed of Al or Ag is disposed on a reflective area of the transmittance adjustment layer.

11. The display apparatus of claim 8, wherein a dielectric coating process is performed on a transmitting area of the transmittance adjustment layer.

12. The display apparatus of claim 1, wherein the transmittance adjustment layer has a bottom surface inclined at a predetermined angle.

13. The display apparatus of claim 12, wherein a recessed portion is defined in a top surface of the transmittance adjustment layer, and a transparent material is filled into the recessed portion.

14. The display apparatus of claim 1, wherein the backlight unit comprises:
a first layer on which the light source is mounted;
a second layer disposed on a top surface of the first layer; and
a light guide layer disposed on the second layer to surround the light source.

15. The display apparatus of claim 14, wherein a hollow part or groove for receiving the light source is defined in the light guide layer.

16. The display apparatus of claim 15, further comprising an adhesion part filled into a space spaced between the hollow part or groove and the light source.

17. The display apparatus of claim 14, further comprising a light extraction pattern disposed on a top surface of the second layer to extract light reflected into the second layer toward the display panel.

18. The display apparatus of claim 14, further comprising a light shield layer disposed on a top surface of the light guide layer, the light shield layer comprising a reflective pattern for blocking a portion of light concentrated around the light source.
